(19) United States
(12) Patent Application Publication
(10) Pub. No.: US 2012/0055516 A1
(43) Pub. Date: Mar. 8, 2012

(54) OPTICAL FIBER STRIPPER APPARATUS AND METHOD

(75) Inventor: Bjorn N. DEBEAR, Moorestown, NJ (US)

(73) Assignee: VYTRAN, LLC, Morganville, NJ (US)

(21) Appl. No.: 13/225,036

(22) Filed: Sep. 2, 2011

Related U.S. Application Data
(60) Provisional application No. 61/379,617, filed on Sep. 2, 2010.

(51) Int. Cl. B08B 3/00

(52) U.S. Cl. 134/28; 134/105

(57) ABSTRACT

In some embodiments, a method includes positioning an outlet of an acid dispenser adjacent to a first portion of an optical fiber. The method includes directing heated acid from the acid dispenser into contact with the first portion of the optical fiber and into a holding tank such that a portion of a coating of the optical fiber is removed to expose a cladding of the optical fiber. The method includes positioning an outlet of a fluid dispenser adjacent to a second portion of the optical fiber. The method includes directing a fluid pressurized at a substantially constant level from the fluid dispenser into contact with the second portion of the optical fiber and into the holding tank such that at least a portion of the heated acid is displaced from the cladding.

### RELATED APPLICATIONS

This application is claims priority to U.S. Provisional Application No. 61/379,617 filed Sep. 2, 2010, and entitled “OPTICAL FIBER STRIPPER APPARATUS,” the contents of which are herein incorporated by reference in its entirety.

### BACKGROUND

Some embodiments described herein relate generally to methods and apparatus for stripping optical fiber.

Known optical fiber stripper apparatus can remove a portion of an optical fiber coating to expose a cladding of the optical fiber. Such known optical fiber stripper apparatus can remove the coating by directing heated acid into contact with the optical fiber to dissolve the coating. While the known optical fiber stripper apparatus can remove optical fiber coatings, the acid can be heated unevenly and can cause charring, cracking, and/or swelling of the remaining optical fiber coating, acid and other fluids can be delivered inconsistently and can cause inconsistent stripping of the optical fiber coating, and errant acid can damage the optical fiber stripper apparatus.

Accordingly, a need exists for an improved apparatus and a method to strip optical fiber coatings.

### SUMMARY

In some embodiments, a method includes positioning an outlet of an acid dispenser adjacent to a first portion of an optical fiber. The method includes directing heated acid from the acid dispenser into contact with the first portion of the optical fiber and into a holding tank such that a portion of a coating of the optical fiber is removed to expose a cladding of the optical fiber. The method includes positioning an outlet of a fluid dispenser adjacent to a second portion of the optical fiber. The method includes directing a fluid pressurized at a substantially constant level from the fluid dispenser into contact with the second portion of the optical fiber and into the holding tank such that at least a portion of the heated acid is displaced from the cladding.

### BRIEF DESCRIPTION OF THE DRAWINGS

FIG. 1 is a block diagram of an optical fiber stripping apparatus according to an embodiment.

FIG. 2 is a front perspective view of an optical fiber stripper apparatus according to an embodiment.

FIG. 3 is a rear perspective view of the optical fiber stripper apparatus shown in FIG. 2.

FIG. 4 is a perspective view of a portion of the optical fiber stripper apparatus shown in FIG. 2.

FIG. 5 is a perspective view of an acid dispenser of the optical fiber stripper apparatus shown in FIG. 2.

FIG. 6 is a perspective view of a portion of the optical fiber stripper apparatus shown in FIG. 2.

FIG. 7 is a side view of a portion of the optical fiber stripper apparatus shown in FIG. 2.

FIG. 8 is a schematic view of an optical fiber stripper system according to an embodiment.

FIG. 9 is a flow chart showing a method of operating an optical fiber stripper apparatus according to an embodiment.

### DETAILED DESCRIPTION

In some embodiments, an apparatus includes a dispenser head including an acid dispenser and a fluid dispenser, the dispensing head configured to move between a first configuration to a second configuration. The acid dispenser includes a heater element configured to heat acid received by the acid dispenser from an acid container; the acid dispenser including an outlet configured to be disposed adjacent a first portion of an optical fiber when the dispensing head is in the first configuration. The acid dispenser is configured to direct heated acid into contact with the first portion of the optical fiber and into a holding tank when the dispensing head is in the first configuration. The fluid dispenser is configured to receive a pressurized fluid from a fluid container, the fluid container being at a substantially constant pressure. The fluid dispenser includes an outlet configured to be disposed adjacent a second portion of the optical fiber when the dispensing head is in the second configuration. The fluid dispenser is configured to direct pressurized fluid into contact with the second portion of the optical fiber and into the holding tank when the dispensing head is in the second configuration.

In some embodiments, a method includes positioning an outlet of an acid dispenser adjacent to a first portion of an optical fiber. The method includes directing heated acid from the acid dispenser into contact with the first portion of the optical fiber and into a holding tank such that a portion of a coating of the optical fiber is removed to expose a cladding or other encased structure of the optical fiber. The method includes positioning an outlet of a fluid dispenser adjacent to a second portion of the optical fiber. The method includes directing a fluid from the fluid dispenser being at a substantially constant pressure into contact with the second portion of the optical fiber and into the holding tank such that at least a portion of the heated acid is displaced from the fiber.

In some embodiments, an apparatus includes an acid dispenser configured to direct acid into contact with an optical fiber, the acid dispenser includes a heater element. The heater element including a first contact point, a second contact point, and at least one heater element portion. The first contact point is disposed substantially near a top of the acid dispenser, the second contact point is disposed substantially near the top of the acid dispenser, and the at least one heater element portion is disposed substantially perpendicular to a flow of acid through the acid dispenser.

As used in this specification, the singular forms “a,” “an” and “the” include plural referents unless the context clearly dictates otherwise. Thus, for example, the term “a container” is intended to mean a single container or a combination of containers. As used in this specification, an acid can include any acid, including, but not limited to, sulfuric acid. Furthermore, acid can include acid in liquid form as well as acid in gaseous form, e.g., acid fumes. Errant acid can include acid being directed away from an intended destination. Said another way, acid may be directed into contact with an optical fiber coating and into a holding tank, and may then be directed to a waste container. A portion of the acid that either does not contact the optical fiber, is not contained in the holding tank, is not directed to the wasted container, or escapes the waste container can be errant acid.

As used herein, an acid-resistant material can include a material, or combinations of materials, that are substantially resistant to acid, e.g., materials that are impervious to, are immune to, and/or resist corrosion due to acid exposure. Some example of acid-resistant materials include Teflon®, Noryl® (a blend of polyphenylene and polystyrene), polybutylene, polypropylene, and can include panels, pastes, coverings, coatings, films, and/or combinations of any of the above.

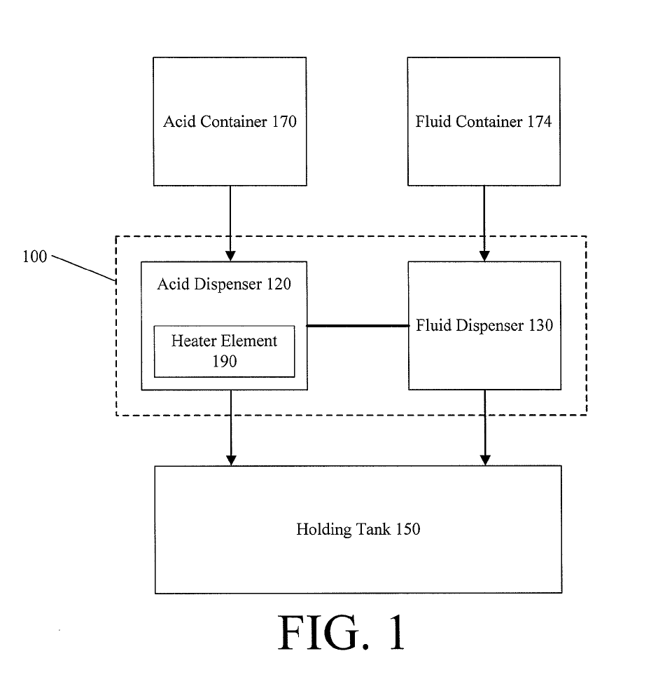

In some embodiments described herein, an optical fiber stripper apparatus can be used to strip, e.g. remove, a coating, jacket and/or other covering from all or a portion of an optical fiber, e.g. a power optical fiber, data optical fiber, sensor optical fiber, or any combination of these fiber types. In some embodiments, the portion of the optical fiber to be stripped can be referred to as the stripping region. FIG. 1 depicts a block diagram of an optical fiber stripper apparatus (“fiber stripper”) 100. Fiber stripper 100 includes an acid dispenser 120 including a heater element 190 that can receive an acid from an acid container 170, and direct the acid to a holding tank 150. The fiber stripper 100 also includes a fluid dispenser 130 that can receive a fluid from a fluid container 174 and direct the fluid to the holding tank 150.

Acid dispenser 120 includes an acid inlet (not shown in FIG. 1), an acid flow channel (not shown in FIG. 1), and an acid outlet (not shown in FIG. 1), and heater element 190. Acid dispenser 120 can include an acid-resistant material. The acid inlet can be configured to receive acid from acid container 170 and direct the acid through the acid flow channel. The acid flow channel can direct the acid from the acid inlet to the acid outlet. The acid flow channel can be heated by heater element 190 such that acid flowing from the acid inlet to the acid outlet through the acid flow channel can be heated. Said another way, acid can be received at the acid inlet at a first temperature, can be directed through the acid channel, and can exit acid dispenser 120 via the acid outlet at a second temperature greater than the first temperature. Heater element 190 can include two heater element contacts (not shown in FIG. 1) configured to supply electrical power to heater element 190. In some embodiments, each of the two heater element contacts can be disposed substantially near the top (e.g., near the acid inlet) of acid dispenser 120. In this manner, all the heater element contacts are disposed substantially near the top of the acid disperser 120 such that errant acid directed from the acid outlet may not contact a heater element contact. A portion of the heater element 190 can run substantially perpendicular to the direction of acid flow through the acid flow channel. In this embodiment, acid directed from the acid outlet can have a substantially uniform temperature. In some embodiments, heater element 190 can include a plurality of portions disposed substantially perpendicular to the direction of flow through the acid channel.

In some embodiments, acid dispenser 120 can include more than one heater element 190. Heater element 190 can include an acid-resistant metal such as platinum. Heater element 190 can be substantially symmetric and includes a substantially serpentine design. In this manner, acid dispenser 120, and subsequently the acid flowing into and through acid dispenser 120, can be uniformly heated such that acid directed into contact with an optical fiber contacts substantially the entire length of the stripping region with acid at substantially the same temperature. Said another way, a first portion of the acid that contacts a left half of the optical fiber portion in the stripping region can be the same temperature as a second portion of the acid that contacts a right half of the optical fiber portion in the stripping region, and the first portion of the acid can contact the left half of the optical fiber portion at substantially the same time as the second portion of the acid can contact the right half of the optical fiber portion. In this manner the stripped portion of the optical fiber can be substantially free of residual coating over the entire surface of the stripping region. The coating on the unstripped fiber regions remains crack-free, not swollen, and/or not charred.

Acid dispenser 120 can be configured to move between a first configuration and a second configuration. When in the first configuration, acid dispenser 120 can be positioned to direct acid into contact with an optical fiber. Specifically, the acid outlet can include a channel (not shown in FIG. 1) such that the acid outlet can be disposed adjacent to a portion of the optical fiber. Acid dispenser 120 can be configured to direct, for example, about one milliliter of acid into contact with the optical fiber. In some embodiments, acid dispenser 120 can direct more or less acid. The amount of acid used can be determined based on characteristics of the acid and/or characteristics of the optical fiber, such as, for example, the size and/or thickness of the optical fiber, size and/or thickness of the coating of the optical fiber, and/or material and/or construction of the coating of the optical fiber. When the acid dispenser is in the second configuration, the fluid dispenser can be positioned to direct fluid into contact with the optical fiber. The amount of acid and/or fluid dispensed from an acid dispenser and/or fluid dispenser can be determined by a user, by software, and/or by firmware. When a determination is made, fiber stripper 100 can be manually, automatically, and/or both manually and automatically set to dispense the determined amount of acid and/or fluid.

Acid dispenser 120 can be coupled to a pump (not shown) disposed between acid dispenser 120 and acid container 170. The pump can be actuated in response to a signal from a control board (not shown in FIG. 1), such as, for example, based on a fiber stripper program or cycle. For example, the pump can be normally off and can be turned on for a predetermined time, such that a predetermined volume of acid is delivered to acid dispenser 120 from acid container 170 and into contact with the optical fiber.

Acid container 170 can be configured to hold an acid and can include an acid-resistant material. Acid container 170 can be coupled to acid dispenser 120 via a conduit, such as, for example, a tube. In some embodiments, an outlet of acid container 170 can be configured to be disposed into the acid inlet of acid dispenser 120.

Holding tank 150 can be configured to receive acid and/or other fluid(s) from acid dispenser 120, fluid dispenser 130, and/or from other sources. Holding tank 150 can include an acid-resistant material and can direct the acid and/or other fluids received in holding tank 150 to a waste container (not shown in FIG. 1). In some embodiments, holding tank 150 can be configured to receive a fluid, such as, for example, water, prior to receiving the acid from acid dispenser 120. In such embodiments, holding tank 150 can receive the water from fluid dispenser 130. Holding tank 150 can be disposed below acid dispenser 120 and fluid dispenser 130 relative to the floor or support on which the fiber stripper 100 and holding tank 150 are disposed such that substantially all the dispensed acid, dispensed fluid, and removed coating is directed by gravity and/or negative pressure into the holding tank 150. Fluid dispenser 130 includes an inlet (not shown in FIG. 1), a fluid flow channel (not shown in FIG. 1), and an outlet (not shown in FIG. 1). The fluid inlet can be configured to receive fluid from fluid container 174 and direct the fluid through the fluid flow channel. The fluid flow channel can direct the fluid from the fluid inlet to the fluid outlet. In some embodiments, fluid dispenser 130 can be configured to direct, for example, about forty milliliters of water into contact with the optical fiber. In some embodiments, fluid dispenser 130 can direct more or less water. The amount of water used can be determined based on characteristics of the optical fiber, such as, for example, the size and/or thickness of the optical fiber, size and/or thickness of the coating of the optical fiber, and/or material and/or construction of the coating of the optical fiber. In some embodiments, the amount of water used can be determined based on characteristics and/or amount of the acid used. In some embodiments, fluid dispenser 130 can include an acid-resistant material.

Fluid dispenser 130 can be configured to move between a first configuration and a second configuration. When in the first configuration, fluid dispenser 130 can be positioned to direct fluid into contact with an optical fiber. Specifically, the fluid outlet can include a channel (not shown) such that the fluid outlet can be disposed adjacent to a portion of the optical fiber. When the fluid dispenser is in the second configuration, the acid dispenser can be in its first configuration and positioned to direct acid into contact with the optical fiber.

Fluid dispenser 130 can be coupled to a solenoid valve (not shown) disposed between fluid dispenser 130 and the fluid container 174. The solenoid valve can be actuated in response to a signal from the control board, such as, for example, based on a fiber stripper program or cycle. For example, the solenoid valve can be normally closed and can be configured to open for a predetermined time, based at least on a pressure of fluid in fluid container 174, such that a predetermined volume of fluid is delivered to fluid dispenser 130 from fluid container 174 and into contact with the optical fiber.

Fluid container 174 can be configured to hold a fluid. Fluid container 174 can be coupled to fluid dispenser 130 via a conduit, such as, for example, a tube (not shown in FIG. 1). In some embodiments, an outlet of fluid container 174 can be configured to be disposed into the fluid inlet of fluid dispenser 130.

In some embodiments, fluid container 174 can be pressurized from a pressure source (not shown in FIG. 1) via a pressure regulator (not shown in FIG. 1) and pressure manifold (not shown in FIG. 1). In this manner, the fluid in fluid container 174 can be under a substantially constant pressure. Said another way, fluid container 174 can include a constant pressure substantially independent of the volume of the fluid in the fluid container. In this manner fluid dispenser 130 can dispense a predetermined amount of the first fluid, for example, as a function of time. By way of a first example, when fluid dispenser 130 dispenses fluid with a fluctuating or variable pressure over a fixed period of time, the volume dispensed over each substantially same fixed period of time can vary. For example, fluid dispenser 130 can dispense a first volume of fluid over a first fixed period of time, for example, five seconds, and can dispense a second volume of fluid different from the first volume of fluid over a second fixed period of time substantially the same length as the first interval, and can dispense a third volume of fluid different from at least one of the first volume of fluid or the second volume of fluid over a third fixed period of time substantially the same length as the first fixed period of time and the second fixed period of time. By way of a second example, when fluid dispenser 130 dispenses uniformly pressurized fluid over a fixed period of time, the volume dispensed over each substantially same fixed period of time can be substantially the same. For example, fluid dispenser 130 can dispense a first volume of fluid over a first fixed period of time, and can dispense a second volume of fluid substantially the same as the first volume of fluid over a second fixed period of time substantially the same length as the first fixed period of time, and can dispense a third volume of fluid substantially the same as the first volume of fluid and the second volume of fluid over a third fixed period of time substantially the same length as the first fixed period of time and the second fixed period of time. While the fixed period of time is described as being, for example, five seconds, the fixed period of time can be longer in duration or shorter in duration. Furthermore, the length of the fixed period of time can change based on characteristics of the optical fiber being stripped and on characteristics of the acids and/or fluids being dispensed. In such embodiments, the fixed period of time can be changed by a user, software, and/or firmware at substantially any time.

In some embodiments, when an optical fiber stripping cycle is initiated, e.g., when an optical fiber is loaded into fiber stripper 100 and a program or other process for stripping a portion of that optical fiber is initiated, fluid container 174 can be pressurized to a predetermined level prior to acid being dispensed by acid dispenser 120 and prior to fluid being dispensed by fluid dispenser 130. In this manner, when a solenoid valve associated with fluid dispenser 130 opens, the fluid is substantially immediately and consistently dispensed. As fluid is dispensed from fluid container 174 and/or as pressure otherwise changes within fluid container 174, the pressure regulator can maintain the predetermined pressure level until, for example, the stripping cycle end, a series of stripping cycles end, and/or a user or processor changes the predetermined level. An optical fiber stripping process and/or program can be a software and/or firmware program embodied in a non-transitory processor-readable medium storing code representing instructions to cause a processor to implement the program. In other embodiments, the optical fiber stripping process can be implemented manually, e.g. a user can manually push a series of buttons in a sequence and/or can manually and/or automatically open and close valves.

In some embodiment, acid dispenser 120 and fluid dispenser 130 can move together. Said another way, acid dispenser 120 and fluid dispenser 130 can be mechanically coupled such that movement of one of acid dispenser 120 or fluid dispenser 130 can cause a substantially similar and synchronous movement of the other. In this manner, a single moving device, such as a dispenser head (not show in FIG. 1), can move both acid dispenser 120 and fluid dispenser 130 between their respective first configuration and second configuration. In such embodiments, when acid dispenser 120 is in its first configuration, fluid dispenser 130 can be in its second configuration, and when acid dispenser 120 is in its second configuration, fluid dispenser 130 can be in its first configuration. In other embodiments, acid dispenser 120 and fluid dispenser 130 can move independently. Said another way, in such other embodiments, movement of one of acid dispenser 120 or fluid dispenser 130 may not affect the movement of the other of acid dispenser 120 or fluid dispenser 130. In this manner, a multiple moving devices, or multiple moving elements of a single moving device, can separately move acid dispenser 120 and fluid dispenser 130 between their respective first configuration and second configuration. In such embodiments, when acid dispenser 120 is in its first configuration, fluid dispenser 130 can be in either its first configuration or second configuration, and when acid dispenser 120 is in its second configuration, fluid dispenser 130 can be in either its first configuration or second configuration.

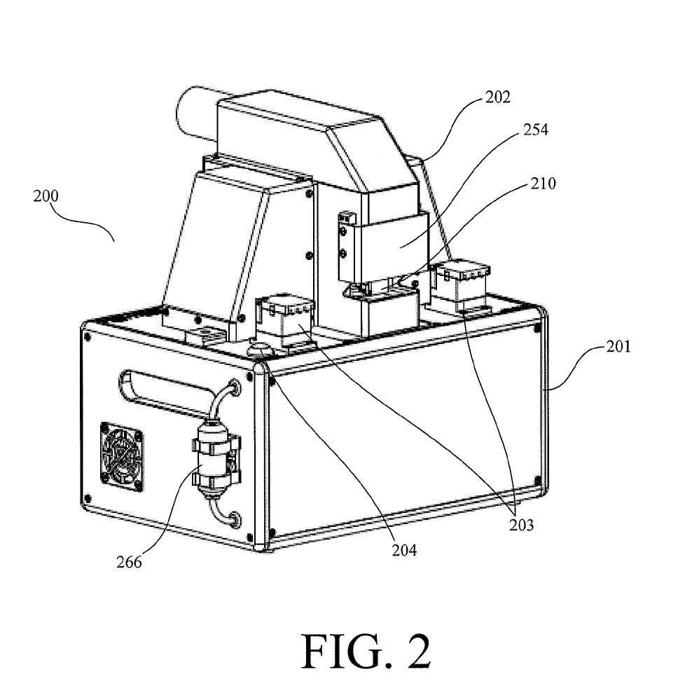

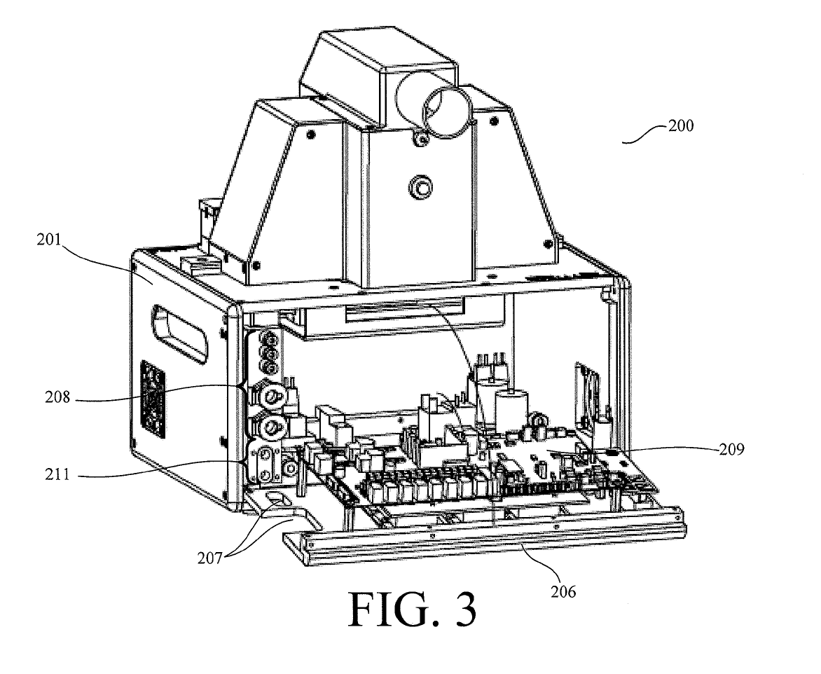

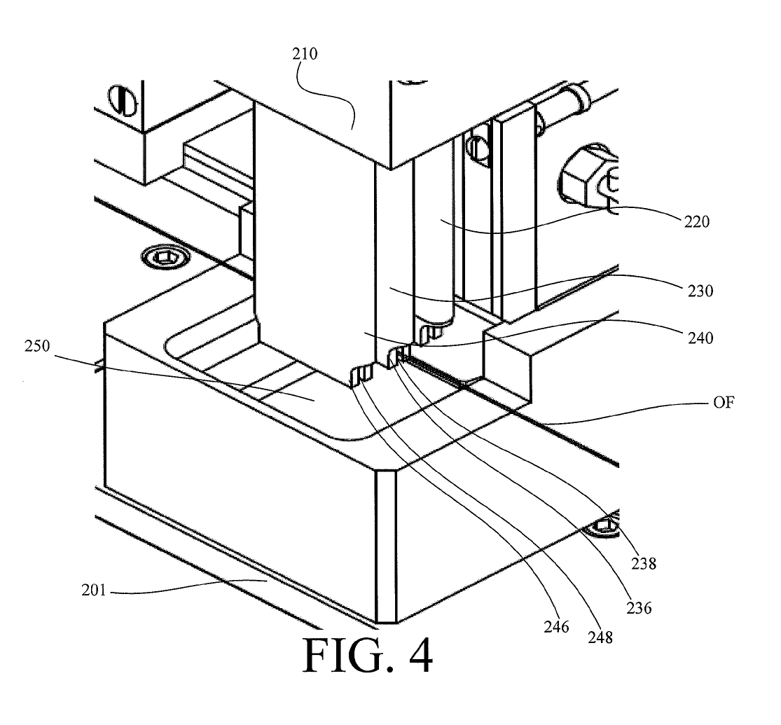

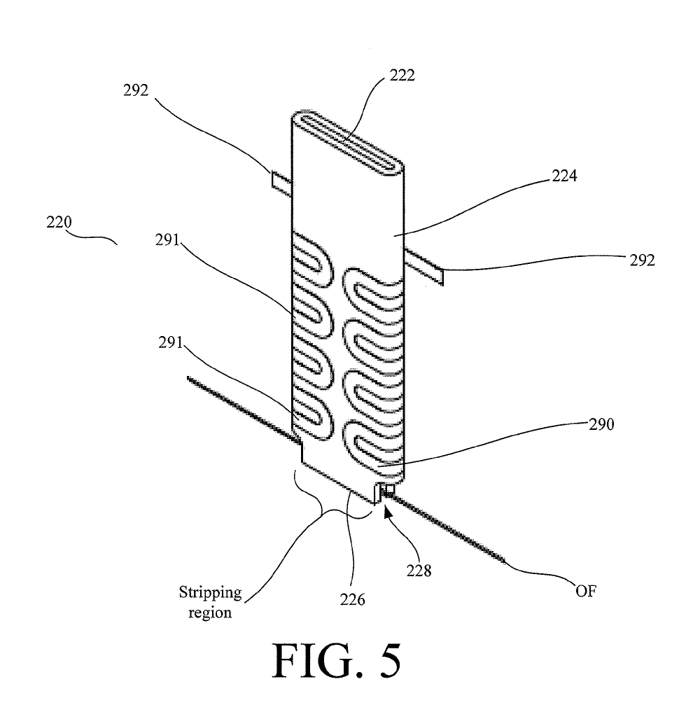

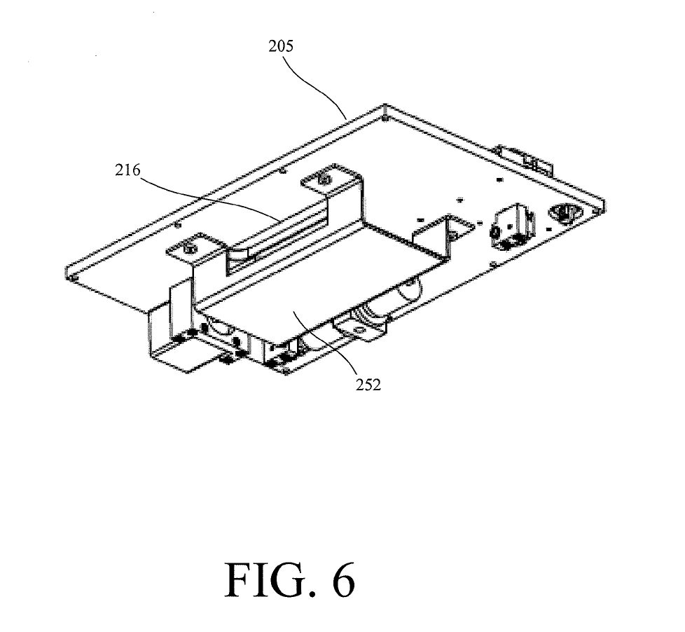

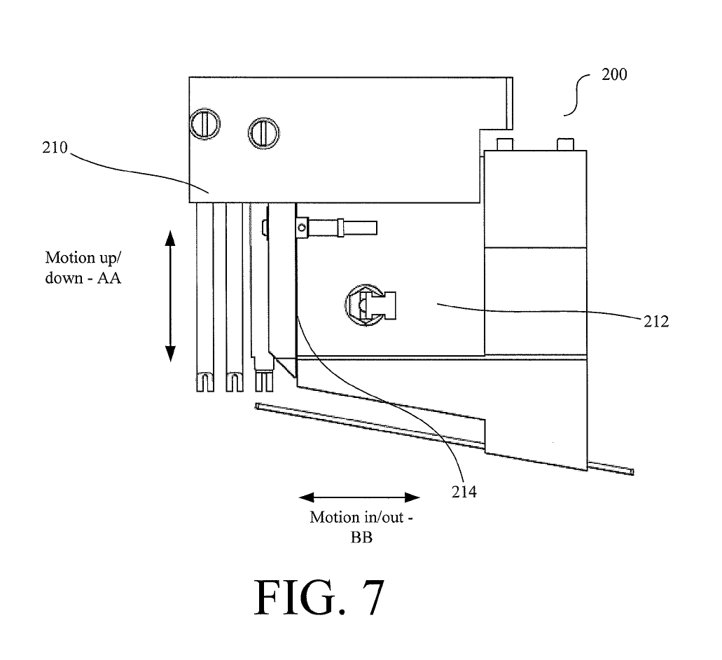

FIGS. 2-7 depict an optical fiber stripper apparatus (“fiber stripper”) 200 according to an embodiment. Specifically, FIG. 2 is a front perspective view of fiber stripper 200; FIG. 3 is a rear perspective view of fiber stripper 200 with a back panel 206 open; FIG. 4 is a perspective view of a portion of fiber stripper 200; FIG. 5 is a perspective view of an acid dispenser 220 of fiber stripper 200; FIG. 6 is a perspective view of a drip guard 252 of fiber stripper 200; and FIG. 7 is a side view of a portion of the fiber stripper 200. Fiber stripper 200 can be similar to, and include similar elements to, fiber stripper 100 described above. By way of example, Fiber stripper 200 can include an acid dispenser 220 (see, e.g., FIG. 4) which can be similar to acid dispenser 120. Fiber stripper 200 can be configured to strip, e.g. remove, a coating, jacket and/or other covering from all or a portion of an optical fiber.

Fiber stripper 200 includes a main housing 201, a dispenser housing 202, a start button 204, and two optical fiber holding blocks (“holding blocks”) 203. Main housing 201 can be configured to house elements of fiber stripper 200 and/or provide a surface to mount elements of fiber stripper 200. By way of example, dispenser housing 202, start button 204, a waste suction filter 266, and the holding block(s) 203 can be mounted, and/or otherwise mechanically coupled to main housing 201. In some embodiments, disposing an optical fiber into holding blocks 203 can position the optical fiber for stripping. Control board 209 can include a processor and/or other computing device and can be configured to implement an optical fiber stripping program or process. An optical fiber stripping process and/or program can be a software and/or firmware program embodied in a non-transitory processor-readable medium storing code representing instructions to cause a processor to implement the program. In other embodiments, the optical fiber stripping process can be implemented manually, e.g. a user can manually push a series of buttons in a sequence and/or can manually and/or automatically open and close valves and/or turn pumps off and on. Pressing start button 204 can turn on fiber stripper 200 and/or initiate a fiber stripper process or method. Start button 204 can include an acid-resistant coating, such as, for example, a rubber coating. While shown as including only a start button 204, in some embodiments, fiber stripper 200 can include other buttons, such as, for example, pneumatic release buttons to, for example, vent a pressurized container and/or otherwise vent fiber stripper 200. In such embodiments, those buttons may also include acid-resistant materials or covers.

As shown in FIG. 3, main housing 201 includes a back panel 206 configured to be opened. Back panel 206 can be configured to selectively enclose or expose at least a portion of the elements of fiber stripper 200 disposed within main housing 201, and can be configured to provide a surface to mount elements of fiber stripper 200, such as, for example, a control board 209. Back panel 206 includes apertures 207 configured to define at least one opening for conduits to be coupled to fiber stripper 200. While FIG. 3 depicts two apertures 207 each having a different shape and configured to have more than one conduit disposed through the one of apertures 207, in some embodiments, back panel 206 can include more or fewer apertures 207, and each aperture 207 can include the same or different shape, and can be configured to allow any number of conduits to pass through. By way of example, back panel 206 can include a single aperture 207 configured such that multiple conduits can be disposed through the single aperture 207. In other embodiments, back panel 206 can include an aperture 207 associated with each individual conduit. In some embodiments, apertures 207 can be configured such that back panel 206 can be opened and/or closed without substantially disturbing a plurality of acid, fluid, and/or pressure inlets 208 and/or a plurality of waste outlets 211. While shown in FIG. 3 as including five inlets and two outlets, in some embodiments, fiber stripper 200 can include more or fewer inlets and/or outlets.

The inlets 208 and the outlets 211 can be configured to couple the conduits to fiber stripper 200. Specifically, the inlet fittings can couple an acid conduit (not shown), a first fluid conduit (not shown), and a second fluid conduit (not shown) to fiber stripper 200, and the outlet fittings can couple at least one waste conduit (not shown in FIGS. 2-7) to fiber stripper 200. In some embodiments, outlets configured to couple to waste conduit(s) (not shown) can be disposed near a bottom of the main housing 201. In this manner, waste that can leak out of the outlet fitting may be less likely to damage fiber stripper 200.

Waste suction filter 266 can be coupled to a waste container (not shown in FIGS. 2-7) and a negative pressure source (not shown) via a conduit (not shown in FIGS. 2-7). The negative pressure source can supply a negative pressure to the waste container to remove waste received by holding tank 250. In some embodiments, acid (including fumes) can be drawn towards the negative pressure source through waste suction filter 266. In such embodiments, waste suction filter 266 can trap the acid and can prevent damage to the negative pressure source. As shown in FIG. 2, waste suction filter 266 can be mounted outside of main housing 201. In this manner, waste suction filter can be easily monitored and changed.

Returning to FIG. 2, guard 254 can include an acid-resistant material, and can be configured to selectively and/or permanently shield and/or otherwise cover at least a portion of a dispensing head 210. Guard 254 can receive errant acid and can hold the errant acid until it evaporates and/or is otherwise disposed of. In some embodiments, guard 254 is permanently and/or semi-permanently coupled to dispenser housing 202, such as, for example, welded and/or fastened. In other embodiments, guard 254 is temporarily coupled to dispenser housing, such as, for example, suspended. Whether a permanent, semi-permanent, and/or temporarily coupled, guard 254 can be hinged such that guard 254 can be moved away from dispenser head 210 to, for example, dispose an optical fiber, adjust dispenser head and or an individual dispenser, and/or for cleaning and/or maintenance.

FIG. 4 shows a portion of fiber stripper 200 with guard 254 removed. As shown in FIG. 4, fiber stripper 200 includes the dispenser head 210 and a holding tub 250. Dispenser head 210 includes an acid dispenser 220, a first fluid dispenser 230, and a second fluid dispenser 240. Dispenser head 210 can be movably coupled to dispenser housing 202 (not shown in FIG. 4).

FIG. 5 shows acid dispenser 220. Acid dispenser 220 includes an acid inlet 222, an acid flow channel 224, and an acid outlet 226, and heater element 290. Acid inlet 222 can be configured to receive acid from an acid container (not shown in FIG. 5) and direct the acid through acid flow channel 224. Acid flow channel 224 can direct the acid from acid inlet 222 to acid outlet 226. Acid flow channel 224 can be heated by heater element 290 such that acid flowing from acid inlet 222 to acid outlet 226 through acid flow channel 224 can be heated. Said another way, acid can be received at acid inlet 222 at a first temperature, can be directed through acid flow channel 224, and can exit acid dispenser 220 via acid outlet 226 at a second temperature greater than the first temperature. Heater element 290 includes two heater element contacts 292 configured to supply power to heater elements 290. As shown in FIG. 5, in some embodiments, each of heat element contacts 292 can be disposed substantially near the top (e.g., near acid inlet 222) of acid dispenser 220. In this manner, errant acid from acid outlet 226 may not contact heater element contacts 292. A portion 291 of the heater element 290 can run substantially perpendicular to the direction of acid flow through the acid flow channel 224. In this embodiment, acid directed from acid outlet 226 can have a substantially uniform temperature. In some embodiments, heater element 290 can include a plurality of portions 291 disposed substantially perpendicular to the direction of flow through the acid channel.

While shown in FIG. 5 as including a single heater element 290, in some embodiments, acid dispenser 220 can include more heater elements 290. Heater element 290 can include an acid-resistant metal such as platinum. As shown in FIG. 5, heater element 290 is substantially symmetric and includes a substantially serpentine design. In this manner, acid dispenser 220, and subsequently the acid flowing into and through acid dispenser 220, can be uniformly heated such that acid directed into contact with an optical fiber OF for substantially the entire length of the stripping region with acid substantially at the same temperature. Said another way, a first portion of the acid that contacts a left half of the optical fiber portion region can be the same temperature as a second portion of the acid that contacts a right half of the optical fiber portion in the stripping region, and first portion of the acid can contact the first half of the optical fiber portion at substantially the same time as the second portion of the acid can contact the right half of the optical fiber portion. In this manner the stripped portion of the optical fiber OF can be substantially free of coating and coating residue.

Acid dispenser 220 can be configured to move between at least a first configuration, a second configuration, and a third configuration. When in the first configuration, acid dispenser 220 can be positioned to direct acid into contact with an optical fiber. Specifically, acid outlet 226 can include a channel 228 such that acid outlet 226 can be disposed adjacent to a portion of the optical fiber OF. Acid dispenser 220 can be coupled to a pump (not shown) disposed between acid dispenser 220 and the acid container (not shown in FIGS. 2-7). The pump can be actuated in response to a signal from control board 209, such as, for example, based on a fiber stripper program or cycle. The pump can be normally off and can be configured to be turned on for a predetermined time, such that a predetermined volume of acid is delivered by acid dispenser 220. Acid dispenser 220 can be configured to direct, for example, about one milliliter of acid into contact with the optical fiber OF. In some embodiments, acid dispenser 220 can direct more or less acid. The amount of acid used can be determined based on characteristics of the optical fiber OF, such as, for example, the size and/or thickness of the optical fiber OF, size and/or thickness of the coating of the optical fiber OF, and/or material and/or construction of the coating of the optical fiber OF.

Returning to FIG. 4, first dispenser 230 includes a first fluid inlet (not shown in FIG. 4), similar to acid inlet 222, a first fluid flow channel (not shown in FIG. 4), similar to acid flow channel 224, and a first fluid outlet 236. The fluid inlet can be configured to receive a first fluid from a first fluid container (not shown in FIGS. 2-7) and direct the first fluid through the first fluid flow channel. The first fluid flow channel can direct the fluid from the fluid inlet to the fluid outlet. In some embodiments, the first fluid can be water. First fluid dispenser 230 can be configured to direct, for example, about forty milliliters of water into contact with the optical fiber. In some embodiments, first fluid dispenser 230 can direct more or less water. The amount of water used can be determined based on characteristics of the optical fiber, such as, for example, the size and/or thickness of the optical fiber, size and/or thickness of the coating of the optical fiber, and/or material and/or construction of the coating of the optical fiber. In some embodiments, the amount of water used can be determined based on characteristics and/or amount of the acid used.

First fluid dispenser 230 can be coupled to a solenoid valve (not shown) disposed between first fluid dispenser 230 and the first fluid container. The solenoid valve can be actuated in response to a signal from control board 209, such as, for example, based on a fiber stripper program or cycle. The solenoid valve can be normally closed and can be configured to open for a predetermined time, based at least on a pressure of first fluid in the first fluid container, such that a predetermined volume of first fluid is delivered by first fluid dispenser 230.

In some embodiments, when an optical fiber stripping cycle is initiated, e.g., when an optical fiber is loaded into fiber stripper 200 and a program or other process for stripping a portion of that optical fiber is initiated, first fluid container 274 can be pressurized to a predetermined level prior to acid being dispensed by acid dispenser 220, prior to fluid being dispensed by first fluid dispenser 230, and prior to second fluid being dispensed by second fluid dispenser 240. In this manner, when a solenoid valve associated with first fluid dispenser 230 opens, the first fluid is immediately and consistently dispensed. As first fluid is dispensed from first fluid container 274 and/or as pressure otherwise changes within first fluid container 274, a pressure regulator can maintain the predetermined pressure level until, for example, the stripping cycle end, a series of stripping cycles end, and/or a user or processor changes the predetermined level.

First fluid dispenser 230 can be configured to move between at least a first configuration and a second configuration. When in the first configuration, first fluid dispenser 230 can be positioned to direct the first fluid into contact with an optical fiber. The position of first fluid dispenser 230 in its first configuration can be substantially similar to the position of acid dispenser 220 in its first configuration. Specifically, first fluid outlet 236 can include a channel 238 such that first fluid outlet 236 can be disposed adjacent to a portion of the optical fiber. Second fluid dispenser 240 includes a second fluid inlet (not shown in FIG. 4) similar to acid inlet 222, a second fluid flow channel (not shown in FIG. 4) similar to acid flow channel 224, and a second fluid outlet 246. The second fluid inlet can be configured to receive a second fluid from a second fluid container (not shown in FIGS. 2-7) and direct the second fluid through the second fluid flow channel. The second fluid flow channel can direct the second fluid from the second fluid inlet to the second fluid outlet 246. In some embodiments, the second fluid can be, for example, an alcohol, such as, for example, an isopropyl alcohol. Second fluid dispenser 240 can be configured to direct about five milliliters of alcohol into contact with the optical fiber. In some embodiments, second fluid dispenser 240 can direct more or less alcohol. The amount of alcohol used can be determined based on characteristics of the optical fiber, such as, for example, the size and/or thickness of the optical fiber, size and/or thickness of the coating of the optical fiber, and/or material and/or construction of the coating of the optical fiber. In some embodiments, the amount of alcohol used can be determined based on characteristics and/or amount of the acid used and/or of the first fluid used.

Second fluid dispenser 240 can be coupled to a solenoid valve (not shown in FIG. 4) disposed between second fluid dispenser 240 and the second fluid container. The solenoid valve can be actuated in response to a signal from control board 209, such as, for example, based on a fiber stripper program or cycle. The solenoid valve can be normally closed and can be configured to open for a predetermined time, based at least on a pressure of second fluid in the second fluid container, such that a predetermined volume of second fluid is delivered by second fluid dispenser 240.

In some embodiments, when an optical fiber stripping cycle is initiated, e.g., when an optical fiber is loaded into fiber stripper 200 and a program or other process for stripping a portion of that optical fiber is initiated, second fluid container (not shown in FIGS. 2-7) can be pressurized prior to acid being dispensed by acid dispenser 220, prior to fluid being dispensed by first fluid dispenser 230, and prior to second fluid being dispensed by second fluid dispenser 240. In this manner, when a solenoid valve associated with second fluid dispenser 240 opens, the second fluid is immediately and consistently dispensed. As second fluid is dispensed from second fluid container 280 and/or as pressure otherwise changes within second fluid container 280, a pressure regulator can maintain the predetermined pressure level until, for example, the stripping cycle end, a series of stripping cycles end, and/or a user or processor changes the predetermined level.

Second fluid dispenser 240 can be configured to move between at least a first configuration, a second configuration, and a third configuration. When in the first configuration, second fluid dispenser 240 can be positioned to direct the second fluid into contact with an optical fiber. Specifically, second fluid outlet 246 can include a channel 248 such that second fluid outlet 246 can be disposed adjacent to a portion of the optical fiber. In some embodiments, the position of the second fluid dispenser in its first configuration can be substantially similar to the position of first fluid dispenser 230 in its first configuration. Similarly, the position of the second fluid dispenser 240 in its first configuration may be substantially similar to the position of acid dispenser 220 in its first configuration.

In some embodiments, the first fluid container 274, and the second fluid container 280 can be pressurized at a substantially constant pressure from a pressure source (not shown in FIGS. 2-7) via a pressure regulator ((not shown in FIGS. 2-7) and pressure manifold (not shown in FIGS. 2-7). Said another way, each of first fluid container 174 and second fluid container 180 can include a constant pressure substantially independent of the volume of the first fluid in the first fluid container 274 and the second fluid in the second fluid container, respectively. In this manner, the first fluid in the first fluid container, and/or the second fluid in the second fluid container can be under a uniform pressure such that first fluid dispenser 230, and/or second fluid dispenser 240 can dispense a predetermined amount of, the first fluid, and/or the second fluid, respectively, for example, as a function of time. For example, when first fluid dispenser 230 dispenses fluid with a fluctuating or variable pressure over a fixed period of time, the volume dispensed over each substantially same fixed period of time can vary. For example, first fluid dispenser 230 can dispense a first volume of first fluid over a first fixed period of time, such as, for example, five seconds, and can dispense a second volume of first fluid different from the first volume of first fluid over a second fixed period of time substantially the same length as the first fixed period of time, and can dispense a third volume of first fluid different from at least one of the first volume of first fluid or the second volume of first fluid over a third fixed period of time substantially the same length as the first fixed period of time and the second fixed period of time. When first fluid dispenser 230 dispenses uniformly pressurized first fluid over a fixed period of time, the volume dispensed over each substantially same fixed period of time can be substantially the same. For example, first fluid dispenser 230 can dispense a first volume of first fluid over a first fixed period of time, can dispense a second volume of first fluid substantially the same as the first volume of first fluid over a second fixed period of time substantially the same length as the first fixed period of time, and can dispense a third volume of first fluid substantially the same as the first volume of first fluid and the second volume of first fluid over a third fixed period of time substantially the same length as the first fixed period of time and the second fixed period of time. While the fixed period of time is described as being, for example, five seconds, the fixed period of time can be longer in duration or shorter in duration. Furthermore, the length of the fixed period of time can change based on characteristics of the optical fiber being stripped and on characteristics of the acids and/or fluids being dispensed. In such embodiments, the fixed period of time can be changed by a user, software, and/or firmware at substantially any time.

Returning to FIG. 4, holding tank 250 can be configured to receive acid and/or other fluid(s) from acid dispenser 220, first fluid dispenser 230, second fluid dispenser 240, and/or from other sources. Holding tank 250 can include an acid-resistant material and can direct the acid and/or other fluids received in holding tank 250 to a waste container (not shown in FIGS. 2-7). In some embodiments, holding tank 250 can be configured to receive a fluid, such as, for example, water, prior to receiving the acid from acid dispenser 220. In some embodiments, holding tank 250 can be configured to receive water from first fluid dispenser 230 prior to receiving acid from acid dispenser 230. Holding tank 250 can be disposed below acid dispenser 220, first fluid dispenser 230, and/or second fluid dispenser 240 relative to the floor or support on which the fiber stripper 200 and holding tank 250 are disposed. Thus, holding tank 250 can receive the acid and/or other fluids.

FIG. 6 shows an underside of top plate 205 of main housing 201. Top plate 205 is disposed between dispensing housing 202 and at least a portion of the components internal to main housing 201, such as, for example, control board 209. Top plate 205 can include a slot 216 to allow acid and/or fluid to flow from their respective dispensers into holding tank 250. A drip guard 252 can be disposed under the slot 216 to protect elements within main housing 201 from acid that may inadvertently overflow from the holding tank 250, if the holding tank is not emptied. Drip guard 252 can include a recessed portion to catch any acid and/or other fluid that may overflow holding tank 250. In some embodiment, drip guard 252 is removable.

In some embodiment, acid dispenser 220, first fluid dispenser 230, and/or second fluid dispenser 240 can be rigidly mechanically coupled to dispenser head 210. In such embodiments, dispensing head 210 can move between at least a first configuration (acid outlet disposed adjacent a first portion of the optical fiber), a second configuration (first fluid outlet disposed adjacent a second potion of the optical fiber), and a third configuration (second fluid outlet disposed adjacent a third portion of the optical fiber). In such embodiments, the positioning of the acid outlet 226, first fluid outlet 236, and second fluid outlet 246 can be referenced based on the configuration of the dispenser head 210. In some embodiments, any of the first portion of the optical fiber, the second portion of the optical fiber, and the third portion of the optical fiber can be the same or different than any other of the first portion of the optical fiber, the second portion of the optical fiber, and the third portion of the optical fiber.

In some embodiment, acid dispenser 220, first fluid dispenser 230, and/or second fluid dispenser 240 can be independently coupled to dispenser head 210 and/or coupled to multiple dispenser heads 210. In such embodiments, each of acid dispenser 220, first fluid dispenser 230, and/or second fluid dispenser 240 can move between a first configuration (outlet disposed adjacent the optical fiber) and a second configuration (outlet not disposed adjacent the optical fiber). In such embodiments, the positioning of the acid outlet 226, first fluid outlet 236, and second fluid outlet 246 can be referenced based on the configuration of the acid dispenser 220, first fluid dispenser 230, and/or second fluid dispenser 240, respectively.

FIG. 7 shows a portion of dispenser head 210. As shown in FIG. 7, dispensing head 210 can be coupled to a sliding block 212 to provide at least a portion of movement in the AA direction and/or the BB direction. Also shown in FIG. 7 is a seam 214. Because seams 214 provide a potential path for acid and/or other fluid to travel within dispenser housing 202 and/or main housing 201, seam 214 can be at least partially coated with an acid-resistant coating, such as, for example, a paste and/or lubricant, such as, for example, a Teflon® paste, to prevent and/or reduce acid and/or other fluid from traveling through either of seam 214 and into dispenser housing 202 and/or main housing 201. While FIG. 7 shows a single seam 214, in other embodiments fiber stripper 200 can have more seams.

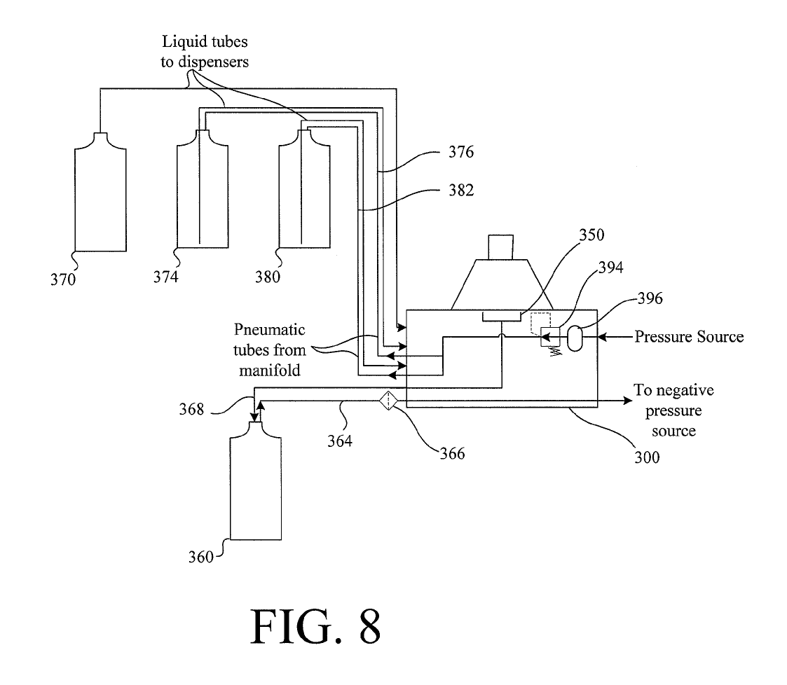

FIG. 8 depicts schematic view of an optical fiber stripper apparatus (“fiber stripper”) 300 according to an embodiment. Fiber stripper 300 can be similar to, and include similar elements to, fiber stripper 100 and fiber stripper 200 as described above. By way of example, fiber stripper 300 can include an acid dispenser (not shown) which can be similar to acid dispenser 120 and/or acid dispenser 220. Fiber stripper 300 can be configured to strip, e.g. remove, a coating, a jacket and/or other covering from all or a portion of an optical fiber.

As shown in FIG. 8, fiber stripper 300 can include a pressure regulator 394 and a manifold 396. Pressure manifold 396 and pressure regulator 394 can manage pressure supplied to first fluid container 374 and second fluid container 380. Pressure from a pressure source (not shown in FIG. 8) can be supplied to first container 374 via pressure manifold 396, pressure regulator 394, and conduit 376, to pressurize a fluid within first fluid container 374. In this manner, the fluid in first fluid container 374 can be under a substantially constant predetermined pressure. Such a first fluid dispenser can dispense a predetermined amount of the fluid, for example, as a function of time. Similarly, pressure from the pressure source can be supplied to second container 380 via pressure manifold 396, pressure regulator 394, and conduit 382, to pressurize a fluid within second fluid container 380. In this manner, the fluid in second fluid container 380 can be under a substantially constant predetermined pressure such that a second fluid dispenser can dispense a predetermined amount of the fluid, for example, as a function of time. While fiber stripper 300 is shown in FIG. 8 as including a single pressure regulator 394, in some embodiments fiber stripper 300 can include more pressure regulators 394. In such embodiments, each of conduit 376 and conduit 382 can be coupled to a separate pressure regulator. In this manner, fluid in first container 374 can be under the same or a different pressure than fluid in the second container 380. In some embodiments, acid container 370 can also be pressurized by the pressure source. In some embodiments, the pressure source can be disposed outside of fiber stripper 300, such as, for example, the pressure source can be an external compressor, compressed air storage tank, “house” air, etc. In some embodiments, the pressure source can be disposed within main housing or a dispenser housing of fiber stripper 300, for example, by an electrically energized compressor housed within the main housing or the dispenser housing. In this manner, fiber stripper 300 may not require any external pressure source.

As shown in FIG. 8, a holding tank 350 is coupled to a waste container 360 via a conduit 368. Waste container 360 can include an acid-resistant material and can be configured to receive acid, fluids, dissolved, and undissolved materials from holding tank 350. Waste container 360 is coupled to a negative pressure source (not shown in FIG. 8) via a conduit 364 and a waste suction filter 366. The negative pressure source can supply a negative pressure to waste container 360 to remove waste received by waste container 360 from holding tank 350. In some embodiments, during the waste removal process, some acid and/or other waste can escape waste container 360 and can travel into conduit 364 towards negative pressure source. In such embodiments, the acid and/or other waste that escapes waste container 360 can be trapped in waste suction filter 366. In some embodiments, the negative pressure source, conduit 364 and/or waste suction filter 366 can be disposed at an elevation below waste container 360. In such embodiments, providing a negative pressure for waste container 360 can assist gravity removing waste from waste container 360. In some embodiments, waste can be removed from holding tank 350 continuously during a cycle. In other embodiments waste can be removed from holding tank 350 at predetermined intervals, such as, for example, once per cycles, once per two cycles, etc. The holding tank 350 can be partially filled with water prior to the acid dispensing phase of a cycle. Water in holding tank 350 can reduce the acid concentration in the holding tank 350. In some embodiments, a drain valve (not shown in FIG. 8) of holding tank 350 can be opened at a predetermined interval, and the waste can be transferred into waste container 360 from the holding tank 350. In other embodiments, the holding tank 350 can be continuously drained into waste container 360. In such embodiments, the drain valve can be opened through a cycle or series of cycles.

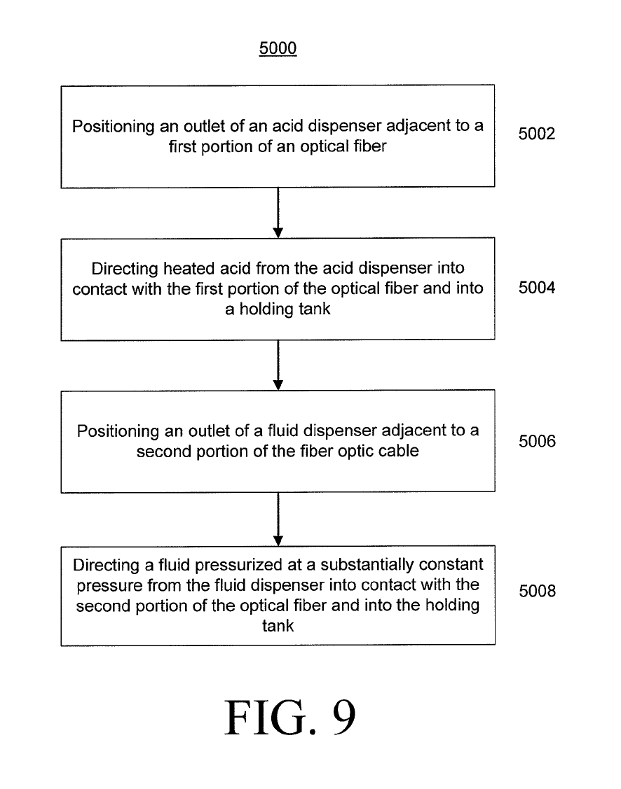

FIG. 9, with reference to FIGS. 2-7, is a flow chart showing a method 5000 of stripping an optical fiber OF using an optical fiber stripper apparatus according to an embodiment (“fiber stripper”), such as, for example, a fiber stripper 200. In some embodiments an optical fiber OF can be disposed in fiber stripper 200, specifically, optical fiber OF can be secured in holding blocks 203. Method 5000 can include positioning acid outlet 226 of acid dispenser 220 adjacent to a first portion of optical fiber OF, at 5002. In some embodiments, acid stored in an acid container can flow through a conduit to acid dispenser 220, and can flow into an acid inlet 222 at a first temperature, through an acid flow channel 224, and to an acid outlet 226 at a second temperature. Acid flowing through acid flow channel 224 can be heated from the first temperature to the second temperature by acid heater 290. Method 5000 can include directing the heated acid from acid dispenser into contact with the first portion of optical fiber OF and into holding tank, at 5004. Directing the heated acid into contact with the first portion of optical fiber OF can remove a coating from the first portion of the optical fiber.

Method 5000 can include positioning first fluid outlet 236 of fluid dispenser 230 adjacent to a second portion of optical fiber OF, at 5006. In some embodiments, a first fluid stored in at a substantially constant predetermined pressure in a first fluid container can flow through a conduit to first fluid dispenser 230, and can flow into a first fluid inlet 232, through a first fluid flow channel, and to first fluid outlet 236. Method 5000 can include directing the substantially constantly pressurized first fluid from fluid dispenser 230 into contact with the second portion of optical fiber OF and into holding tank, at 5008. Directing the substantially constantly pressurized first fluid into contact with the second portion of optical fiber OF can displace at least a portion of the heated acid from the second portion. In some embodiments, the substantially constantly pressurized first fluid can be water.

In some embodiments, stripping an optical fiber can further include positioning second fluid outlet 246 of second fluid dispenser 240 adjacent to a third portion of optical fiber OF. In such embodiments, a second fluid stored in a second fluid container can flow through a conduit to second fluid dispenser 240, and can flow into a second fluid inlet, through an second fluid flow channel, and to second fluid outlet 246. In some embodiments, stripping an optical fiber can further include directing the second fluid from fluid dispenser 230 into contact with the third portion of optical fiber OF and into holding tank. Directing the second fluid into contact with the third portion of optical fiber OF can displace at least a portion of the first fluid from the third portion. In some embodiments, the second fluid can be an alcohol, for example, isopropyl alcohol.

In some embodiments, moving each of acid dispenser 220, first fluid dispenser 230, and/or second fluid dispenser 240 can include moving dispenser head 210. In some embodiments, the first portion of the optical fiber, the second portion of the optical fiber, and the third portion of the optical fiber can be substantially the same. In other embodiments, the first portion of the optical fiber, the second portion of the optical fiber, and the third portion of the optical fiber can be different. For example, acid dispenser 220 can be positioned about a length of optical fiber OF substantially directly above that length (first portion), first fluid dispenser 230 can be positioned about that length of optical fiber OF offset from substantially directly above that length, for example, at a 45 degree angle (second portion), and second fluid dispenser 240 can be positioned about that length of optical fiber OF offset from substantially directly above that length, for example, at a 45 degree angle opposite the first fluid dispenser (third portion).

In some embodiments, stripping an optical fiber can include pressurizing one or both of the first fluid container and the second fluid container at a substantially constant predetermined pressure. In such embodiments the first fluid container and the second fluid container can be pressurized to the same or different pressures. Pressurizing one or both of first fluid container and second fluid container can pressurize one or both of the first fluid and the second fluid.

In some embodiment, stripping an optical fiber can include directing acid, first fluid, and/or second fluid received by holding tank 250 to a waste container. In some embodiments, a negative pressure can be applied to the waste container, and can draw acid, first fluid, and/or second fluid from holding tank 250 to the waster container. As discussed above, in some embodiments, waste can be drained from holding tank 250 to the waste container continuously, or after a predetermined number of cycles.

While various embodiments have been described above, it should be understood that they have been presented by way of example only, not limitation, and various changes in form and details may be made. For example, while FIG. 8 depicts the acid container 370, first fluid container 374, and the second fluid container 380 being disposed outside of fiber stripper 300, in some embodiments, any and/or all of the acid container 370, first fluid container 374, and the second fluid container 380 can be disposed within, on, or outside of fiber stripper 300. Likewise the vertical position of these containers relative to the fiber stripper 200 can be varied. That is they may be placed either above or below the fiber stripper 200. Similarly, while FIG. 2 depicts waste suction filter 266 being mounted to a side of fiber stripper 200, in some embodiments, waste suction filter 266 can be mounted inside of fiber stripper 200 and can be accessible via back panel 206. In another example, while FIGS. 2-7, depict fiber stripper 200 having holding tank 250 integrated into fiber stripper 200, in other embodiments, holding tank 250 can be a preexisting structure, such as, for example, a sink, and fiber stripper 200 can be configured to be mounted onto that preexisting structure and/or a nearby structure. In such embodiments, main housing and dispensing housing can be integrated and/or rearranged.

By way of another example, while FIG. 5 depicts the stripping region as substantially the same length as the length of the acid outlet, in some embodiments, the length of the acid outlet can be less than the length of the stripping region. In such embodiments, the acid and/or fluid dispensers can be configured to travel along a length of the optical fiber to remove the optical fiber coating along the stripping region.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

Where methods described above indicate certain events occurring in certain order, the ordering of certain events can be modified. Additionally, certain of the events can be performed concurrently in a parallel process when possible, as well as performed sequentially as described above. Any portion of the apparatus and/or methods described herein may be combined in any combination, except mutually exclusive combinations. The embodiments described herein can include various combinations and/or sub-combinations of the functions, components and/or features of the different embodiments described. Furthermore, value for various volume, temperature, and/or time measurements are given for exemplary purposes only. For example, while described as using about 40 ml of fluid, e.g., water, more or less fluid may be used.

What is claimed is:

1. An apparatus, comprising:
a dispenser head including an acid dispenser and a fluid dispenser, the dispensing head configured to move between a first configuration to a second configuration;
the acid dispenser including a heater element configured to heat acid received by the acid dispenser from an acid container; the acid dispenser including an outlet disposed adjacent a first portion of an optical fiber when the dispensing head is in the first configuration; the acid dispenser configured to direct heated acid into contact with the first portion of the optical fiber and into a holding tank when the dispensing head is in the first configuration; and
the fluid dispenser configured to receive a pressurized fluid from a fluid container being at a substantially constant pressure; the fluid dispenser including an outlet configured to be disposed adjacent a second portion of the optical fiber when the dispensing head is in the second configuration; the fluid dispenser configured to direct pressurized fluid into contact with the second portion of the optical fiber and into the holding tank when the dispensing head is in the second configuration.

2. The apparatus of claim 1, wherein the acid dispenser is configured to direct heated acid into contact with the first portion of the optical fiber to remove a coating of the optical fiber.

3. The apparatus of claim 1, wherein the dispenser head is slidably disposed along a seam, the seam substantially coated with an acid-resistant substance.

4. The apparatus of claim 1, wherein the fluid dispenser is a first fluid dispenser, the pressurized fluid is a first pressurized fluid, and the fluid container is a first fluid container, further including:
a second fluid dispenser configured to receive a second pressurized fluid from a second fluid container;
the second fluid dispenser configured to direct the pressurized second fluid into contact with a third portion of the optical fiber and into the holding tank.

5. The apparatus of claim 1, wherein at least a portion of the acid is errant acid, the apparatus further including a guard, at least a portion of the guard disposed to block at least a portion of the errant acid.

6. The apparatus of claim 1, wherein the heater element includes only two contact, each of the two contacts are disposed substantially near a top of the acid disperser

7. The apparatus of claim 1, further including:
a conduit configured to connect the fluid container to the fluid dispenser, and;
an access panel disposed about at least a portion of the conduit, the access panel configured to move from a closed position to an open position while maintaining the connection between the fluid container and the fluid dispenser.

8. The apparatus of claim 1, further including a housing, the holding tank configured to be emptied through a waste filter mounted external to a housing.

9. A method, comprising:
positioning an outlet of an acid dispenser adjacent to a first portion of an optical fiber;
directing heated acid from the acid dispenser into contact with the first portion of the optical fiber and into a holding tank such that a portion of a coating of the optical fiber is removed to expose a cladding of the optical fiber;
positioning an outlet of a fluid dispenser adjacent to a second portion of the optical fiber; and
directing a fluid pressurized at a substantially constant level from the fluid dispenser into contact with the second portion of the optical fiber and into the holding tank such that at least a portion of the heated acid is displaced from the cladding.

10. The method of claim 9, wherein the first portion of the optical fiber is substantially the same as the second portion of the optical fiber.

11. The method of claim 9, wherein the fluid dispenser is a first fluid dispenser and the fluid is a first fluid, the method further comprising:
positioning an outlet of a second fluid dispenser adjacent to a third portion of the optical fiber; and
directing a second fluid from the second fluid dispenser into contact with the third portion of the optical fiber and into the holding tank such that at least a portion of the first fluid is displaced from the cladding.

12. The method of claim 11, wherein the second fluid is pressurized at a substantially constant level in the second fluid dispenser.

13. The method of claim 9, further including directing acid and fluid in the holding tank to a waste container through a waste filter.

14. The method of claim 9, further comprising disposing an amount of water into the holding tank prior to the dispensing of acid from the acid dispenser.

15. An apparatus, comprising:
an acid dispenser configured to direct acid into contact with an optical fiber, the acid dispenser including a heater element;
the heater element including a first contact point, a second contact point, and at least one heater element portion, the first contact point disposed substantially near a top of the acid dispenser, the second contact point disposed substantially near the top of the acid dispenser, and the at least one heater element portion disposed substantially perpendicular to a flow of acid through acid dispenser.

16. The apparatus of claim 15, wherein the at least one heater element portion is a plurality of heater element portions, each heater element portion from the plurality of heater element portions disposed perpendicular to a flow of acid through the acid dispenser.

17. The apparatus of claim 15, wherein the heater element includes platinum.

18. The apparatus of claim 15, wherein the heater element includes a substantially serpentine pattern along a length of the acid dispenser.

19. The apparatus of claim 15, wherein the heater element is configured to uniformly heat, along the substantially the entire length of an acid outlet of the acid dispenser, acid directed at the optical fiber.

20. The apparatus of claim 15, wherein the first contact, and the second contact, are the only contacts.
